(19) United States
(12) Patent Application Publication
(10) Pub. No.: US 2005/0028271 A1
(43) Pub. Date: Feb. 10, 2005

(54) Vacuum relief valve for use in a shower head

(76) Inventor: Robert J. Sallick, Danbury, CT (US)

Correspondence Address: GOODWIN PROCTER L.L.P, 103 EISENHOWER PARKWAY, ROSELAND, NJ, 07068, US

(21) Appl. No.: 10/634,945

(22) Filed: Aug. 5, 2003

(51) Int. Cl. A47K 3/022; B05B 9/00

(52) U.S. Cl. 4/615; 239/124

(57) ABSTRACT

Provided herein is a valve having a cylindrical body having a threaded portion on the outside thereof and a cylindrical bore in the inside thereof; the cylindrical body has an air hole at the top thereof communicating with the bore; a ball is situated in the bore: and a screw closes an end of the bore to hold the ball therein. The improved vacuum relief valve also includes a gasket fitted inside the bore between the ball and the air hole. The invention also includes a shower head which includes the improved vacuum relief valve.

### FIELD OF THE INVENTION

This invention relates to an improved vacuum relief valve for use in a shower head and particularly to an improved vacuum relief valve for use in a shower head which is mounted parallel with the floor.

### BACKGROUND OF THE INVENTION

Most shower heads are designed to be mounted at an angel other than zero with respect to the floor or level. Thus, such shower heads are designed to be mounted relatively close to a wall and the water is expected to spray out to a person taking a shower. In this configuration, when the water is turned off the water remaining in the pipe and the shower head flows out into the shower enclosure through the same holes as when the water is turned on.

Well over fifty years ago shower heads were often mounted out from the wall and parallel with the floor. If the shower head were truly level the water in the shower head and pipe would remain there when the water was turned off and allow for mildew, mold and other unwanted things to breed. Often a crude vacuum relief valve was included in the shower head to alleviate this problem.

### BRIEF DESCRIPTION OF THE INVENTION

In order to fulfill the need for an improved vacuum relief valve there is provided a valve having a cylindrical body having a threaded portion on the outside thereof and a cylindrical bore in the inside thereof; the cylindrical body has an air hole at the top thereof communicating with the bore; a ball is situated in the bore: and a screw closes an end of the bore to hold the ball therein. The improved vacuum relief valve also includes a gasket fitted inside the bore between the ball and the air hole.

The invention also includes a shower head which includes the improved vacuum relief valve.

### DESCRIPTION OF THE DRAWINGS

The invention will be described in the following detailed description that will be referring to the drawings as follows:

FIG. 1: Is a front elevation view showing a shower head mounted parallel with a floor, said shower head including an improved vacuum relief valve in accordance with the teachings of this invention.

FIG. 2: Is a side view of a shower head including the vacuum relief valve of this invention which can be mounted parallel with the floor or used as a hand held shower head.

FIG. 3: Is a top view of the shower head including the vacuum relief valve of this invention shown in FIG. 2

FIG. 4: Is a side view of the vacuum relief valve of this invention.

FIG. 5: Is an exploded view of the improved vacuum relief valve of this invention to show the parts thereof.

FIG. 6: Is a sectional view along the line 6-6 in FIG. 3 to show the internal configuration of important elements of this invention.

### DETAILED DESCRIPTION OF THE INVENTION

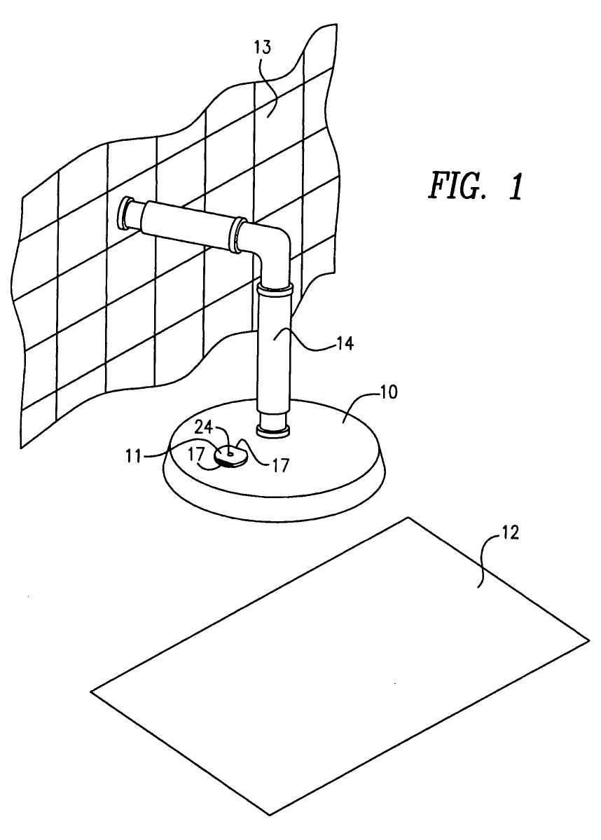

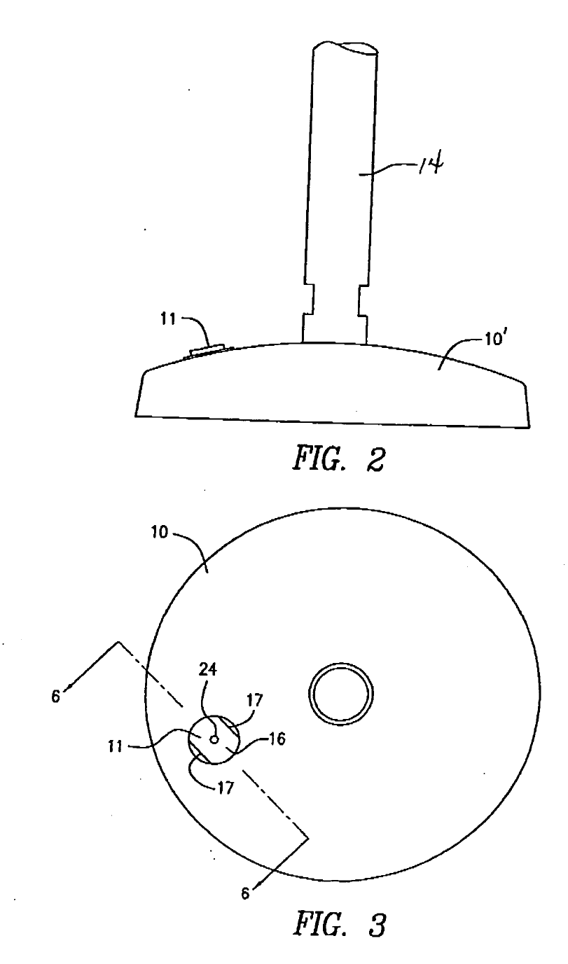

Referring now to FIG. 1 we see, a shower head 10 including an improved vacuum relief valve 11. The shower head 10 is mounted parallel with a floor 12 from a wall 13 by pipes 14. In FIG. 2 we see an alternative embodiment of the shower head 10 including the improved vacuum relief valve 11, the shower head extending from a hose 14, which could be mounted from a ceiling or wall or used as a hand held shower head.

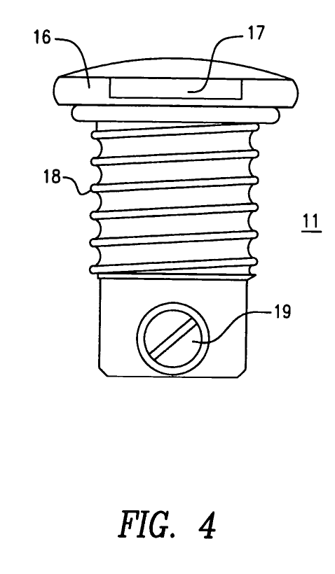

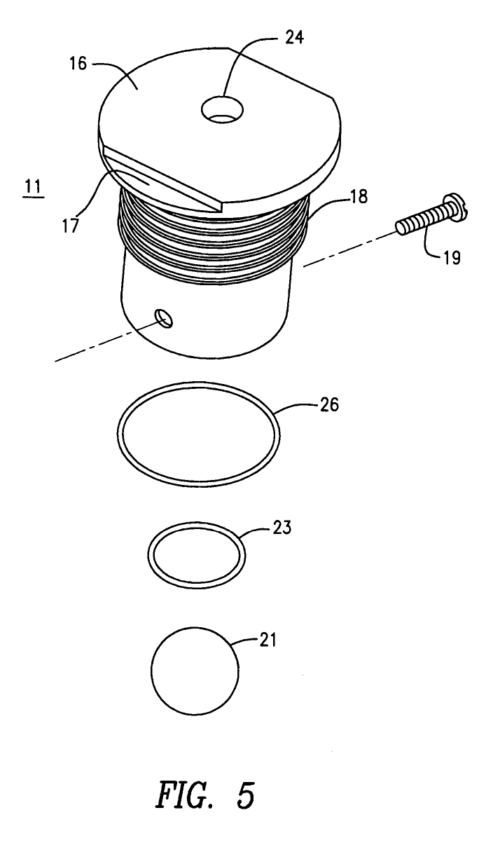

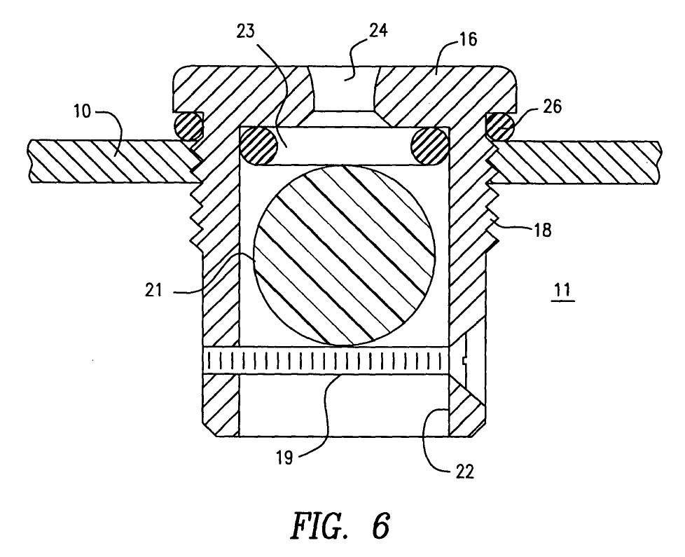

Referring now to FIGS. 3 and 4, we see, the improved vacuum relief valve 11 which is mounted in the shower head 10. The vacuum relief valve 11 has a head 16 with flattened sides 17 to be grasped by a tightening tool. The vacuum relief valve 11 has a cylindrical body 18 and is threaded on a portion thereof. At the bottom of the vacuum relief valve 11 is a screw 19 which can be seen better in FIGS. 5 and 6.

Referring now to FIGS. 5 and 6, we see, that the vacuum relief valve 11 has a light weight sturdy ball 21 which sits inside a cylindrical bore 22 in the body 18. The screw 19 closes the end of the bore 22 to hold the ball 21 therein. A gasket 23 fits snugly in the top of the bore 22 and the body 18 has an air hole 24 at the top thereof. The inside diameter of gasket 23 is smaller than the outside diameter of ball 18. A second gasket 26 fits between the top of vacuum relief valve 11 and shower head 10 to prevent water leakage.

In operation, when the water is turned on, water pressure causes the ball to press up against gasket 23 sealing the valve preventing water from flowing out through hole 24. When the water is turned off the pressure of the water drops allowing some air through hole 24 to allow the water to drain. In this way a vacuum cannot form preventing the water from fully draining.

Having now described exemplary embodiments of the invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, and equivalents or similar purpose, unless expressly stated otherwise. Therefore, numerous other embodiments of the modifications thereof are contemplated as falling within the scope of the present invention as defined by the appended claims and equivalents thereto.

1. An improved vacuum relief valve for use in a shower head mounted parallel to a floor, including:
a cylindrical body having a threaded portion on the outside thereof and a cylindrical bore in the inside thereof;
said cylindrical body having an air hole at the top thereof communicating with said bore;
a ball situated in said bore; and
a screw closing an end of said bore to hold said ball therein;
wherein said valve facilitates the prevention of water being suspended in said parallel mounted shower head.

2. The improved vacuum relief valve as described in claim 1 also including a gasket fitted inside said bore between said ball and said air hole.

3. A shower head mounted parallel to the floor, including: said improved vacuum relief valve as described in claim 1.

4. A shower head mounted parallel to the floor, including: said improved vacuum relief valve as described in claim 2.
